(19) United States
(12) Patent Application Publication
(10) Pub. No.: US 2021/0232145 A1
(43) Pub. Date: Jul. 29, 2021

(54) INFORMATION PROCESSING APPARATUS, NON-TRANSITORY STORAGE MEDIUM, AND INFORMATION PROCESSING METHOD

(71) Applicant: TOYOTA JIDOSHA KABUSHIKI KAISHA, Toyota-shi (JP)

(72) Inventors: Katsuhisa YOSHIKAWA, Toyota-shi (JP); Yuji SUZUKI, Kariya-shi (JP); Keita YAMAZAKI, Nisshin-shi (JP); Kei MATSUMOTO, Toyota-shi (JP); Hiroyuki ITO, Nagoya-shi (JP); Takashi OGAWA, Toyota-shi (JP); Yukiya SUGIYAMA, Toyota-shi (JP); Masaru ANDO, Seto-shi (JP); Yasushi FUJIWARA, Toyota-shi (JP); Azusa NAKAGAME, Kariya-shi (JP); Erina TOYAMA, Toyota-shi (JP)

(73) Assignee: TOYOTA JIDOSHA KABUSHIKI KAISHA, Toyota-shi (JP)

(21) Appl. No.: 17/160,693

(22) Filed: Jan. 28, 2021

(30) Foreign Application Priority Data
Jan. 29, 2020 (JP) 2020-012527

(51) Int. Cl. G05D 1/02; B60L 58/12; G05D 1/00; B60K 1/04; B60K 15/03

(52) U.S. Cl. CPC G05D 1/0217; B60L 58/12; B60K 15/03; G05D 1/0287; B60K 1/04; G05D 1/0088

(57) ABSTRACT

An information processing apparatus disclosed includes a controller configured to execute the processing of acquiring a remaining amount of energy source defined as the remaining amount of energy source stored in the storage unit of a first chassis unit coupled with a specific vehicle body unit, and when the remaining amount of energy source is smaller than a predetermined threshold, sending a decoupling command to the first chassis unit and sending a coupling command to a second chassis unit for which replenishment of energy source has been completed. The decoupling command is a command to decouple the first chassis unit from the vehicle body unit, and the coupling command is a command to couple the second chassis unit to the specific vehicle body unit.

### CROSS REFERENCE TO RELATED APPLICATION

This application claims the benefit of Japanese Patent Application No. 2020-012527, filed on Jan. 29, 2020, which is hereby incorporated by reference herein in its entirety.

### BACKGROUND

### Technical Field

This disclosure pertains to technologies relating to management of separable vehicles.

### Description of the Related Art

There are known separable vehicles constructed by combining a plurality of separable units (see, for example, Patent Document 1 in the citation list below).

### CITATION LIST

### Patent Literature

Patent Literature 1: DE 10 2009 057 693

### SUMMARY

An object of this disclosure is to improve the convenience of users of separable vehicles.

Disclosed herein is an information processing apparatus for managing a separable vehicle including a vehicle body unit having a space capable of accommodating an occupant and/or goods and a chassis unit adapted to be coupled to and decoupled from the vehicle body unit and having a motor and a storage unit that stores energy source of the motor. The information processing apparatus may comprise a controller including at least one processor. The controller may be configured to execute the processing of:

acquiring a remaining amount of energy source defined as the remaining amount of energy source stored in the storage unit of a first chassis unit coupled with a specific vehicle body unit; and

when the remaining amount of energy source is smaller than a predetermined threshold, sending a decoupling command to the first chassis unit and sending a coupling command to a second chassis unit for which replenishment of energy source has been completed, the decoupling command being a command to decouple the first chassis unit from the vehicle body unit, and the coupling command being a command to couple the second chassis unit to the specific vehicle body unit.

Also disclosed herein is an information processing program for managing a separable vehicle including a vehicle body unit having a space capable of accommodating an occupant and/or goods and a chassis unit adapted to be coupled to and decoupled from the vehicle body unit and having a motor and a storage unit that stores energy source of the motor, or a non-transitory storage medium stored with the information processing program. The information processing program may be configured to cause a computer to execute the processing of

acquiring a remaining amount of energy source defined as the remaining amount of energy source stored in the storage unit of a first chassis unit coupled with a specific vehicle body unit; and

when the remaining amount of energy source is smaller than a predetermined threshold, sending a decoupling command to the first chassis unit and sending a coupling command to a second chassis unit for which replenishment of energy source has been completed, the decoupling command being a command to decouple the first chassis unit from the vehicle body unit, and the coupling command being a command to couple the second chassis unit to the specific vehicle body unit.

Also disclosed herein is an information processing method for managing a separable vehicle including a vehicle body unit having a space capable of accommodating an occupant and/or goods and a chassis unit adapted to be coupled to and decoupled from the vehicle body unit and having a motor and a storage unit that stores energy source of the motor. The information processing method may comprise the following steps of processing executed by a computer:

acquiring a remaining amount of energy source defined as the remaining amount of energy source stored in the storage unit of a first chassis unit coupled with a specific vehicle body unit; and

when the remaining amount of energy source is smaller than a predetermined threshold, sending a decoupling command to the first chassis unit and sending a coupling command to a second chassis unit for which replenishment of energy source has been completed, the decoupling command being a command to decouple the first chassis unit from the vehicle body unit, and the coupling command being a command to couple the second chassis unit to the specific vehicle body unit.

The present disclosure can provide a technology that can improve the convenience of users of separable vehicles.

### BRIEF DESCRIPTION OF THE DRAWINGS

FIG. 1 is a diagram illustrating the general configuration of a vehicle management system.

FIG. 2 is a first diagram illustrating the general configuration of a separable vehicle.

FIG. 3 is a second diagram illustrating the general configuration of the separable vehicle.

FIG. 4 is a diagram illustrating the hardware configurations of a chassis unit, a vehicle body unit, and a server apparatus.

FIG. 5 is a block diagram illustrating an exemplary functional configuration of the chassis unit.

FIG. 6 is a block diagram illustrating an exemplary functional configuration of the server apparatus.

FIG. 7 illustrates an exemplary structure of a chassis unit information table.

FIG. 8 is a flow chart of a process executed by the server apparatus.

### DESCRIPTION OF THE EMBODIMENTS

The technology disclosed herein is characterized by that when the remaining amount of energy source of a chassis unit coupled with a specific vehicle body unit becomes smaller than a predetermined threshold, the chassis unit coupled with the specific vehicle body unit is replaced automatically with another chassis unit.

The term “energy source” used here refers to an energy source used for operation of a motor provided in the chassis unit. For example, in the case where the motor of the chassis unit is an internal combustion engine or a hybrid system of an electric motor and an internal combustion engine, the energy source is fuel (e.g. gasoline or light oil). In the case where the motor of the chassis unit is an electric motor, the energy source is electricity. The term “remaining amount of energy source” refers to the remaining amount of energy source stored in a storage unit provided in the chassis unit. In the case where the motor of the chassis unit is an internal combustion engine, the remaining amount of energy source means the remaining amount of fuel stored in the storage unit (i.e. fuel tank). In the case where the motor of the chassis unit is an electric motor, the remaining amount of energy source means the remaining charge in a storage unit (i.e. battery) or the remaining battery capacity.

When the remaining amount of energy source of the chassis unit becomes small, it is necessary to move the separable vehicle (or the chassis unit) to a replenishing facility (e.g. a charging facility or a service station) and replenish the energy source of the chassis unit. It may take time for the user of the chassis unit to do so. In the case where the motor of the chassis unit is an electric motor, if there is no charging facility in the neighborhood of the home of the user, it is necessary for the user to provide a charging equipment in the user's home. This may place an increased economic burden on the user.

The technology disclosed herein takes advantage of characteristics of the separable vehicle to solve the above problem. Specifically, when the remaining amount. of energy source of the chassis unit becomes small, the chassis unit is replaced automatically with another chassis unit for which replenishment of energy source has been completed. The chassis unit for which replenishment of energy source has been completed refers to a chassis unit whose storage unit is filled (or charged) with energy source almost fully.

More specifically, a controller of an information processing apparatus according to this disclosure firstly acquires the remaining amount of energy source of a chassis unit (first chassis unit) coupled with a specific vehicle body unit. For example, the controller may acquire the remaining amount of energy source of the first chassis unit by communicating with the first chassis unit at predetermined intervals. Alternatively, the first chassis unit may be configured to send information about the remaining amount of energy source thereof to the information processing apparatus when it is detected that the remaining amount of energy source thereof becomes smaller than a predetermined threshold, and the controller may acquire the remaining amount of energy source on the basis of this information.

When the remaining amount of energy source acquired as above is smaller than a predetermined threshold, the controller sends a decoupling command to the first chassis unit and a coupling command to a second chassis unit. The decoupling command is a command to decouple (or separate) the first chassis unit from the specific vehicle body unit. The coupling command is a command to couple the second chassis unit to the specific vehicle body unit. The second chassis unit is a chassis unit for which replenishment of energy source has been completed.

After receiving the decoupling command, the first chassis unit decouples itself from the specific vehicle body unit. The operation of decoupling the first chassis unit from the specific vehicle body unit may be carried out by an external apparatus equipped with a heavy machine, such as a lift or a crane. Alternatively, the operation of decoupling the first chassis unit from the specific vehicle body unit may be carried out by an apparatus provided on the first chassis unit or the specific vehicle body unit. After the first chassis unit and the specific vehicle body unit are decoupled, the vehicle body unit can be coupled to a chassis unit other than the first chassis unit. Then, the second chassis unit that has received the coupling command couples itself to the specific vehicle body unit. The operation of coupling the second chassis unit and the specific vehicle body unit may be carried out by an external apparatus like one described above or an apparatus provided on the second chassis unit or the specific vehicle body unit.

The technology disclosed herein can save the user of the separable vehicle the trouble of replenishing the energy source when the remaining amount of energy source of the chassis unit becomes small. Moreover, in the case where the moto of the chassis unit is an electric motor, this technology can save the user the cost of providing a charging facility in the user's home or other places. Hence, this technology can enhance the convenience of the user of the separable vehicle.

The first and second chassis units may be configured to travel by either manual driving by a human driver or autonomous driving. In the case where the first and second chassis units are capable of travelling autonomously, the replacement of the chassis unit coupled with the specific vehicle body unit can be carried out without human intervention. This can enhance the efficiency of the operation of replacing the chassis unit.

The aforementioned decoupling command may include the following two commands:
first command: a command to decouple the first chassis unit from the specific vehicle body unit at a specific location
second command: a command to cause the first chassis unit to travel from the specific location to a specific replenishing facility

After receiving the decoupling command, the first chassis unit operates pursuant to the first command to decouple the specific vehicle body unit and the first chassis unit from each other at the specific location. The specific location is, for example, a location where the first chassis unit is parked. When the first chassis unit is running, the parking lot closest to the present location of the first chassis unit may be selected as the specific location. The specific location may be selected arbitrarily by the user. After the first chassis unit is separated from the specific vehicle body unit at the specific location, the first chassis unit travels by autonomous driving pursuant to the second command to the specific replenishing facility. Thus, the replenishment of energy source of the first chassis unit can be carried out without requiring the efforts of the user. After the completion of the replenishment of energy source, the first chassis unit may be put on standby at the specific replenishing facility. Alternatively, the first chassis unit may travel autonomously to a certain parking site and be stored in the parking site.

The coupling command may include the following two commands:
third command: a command to cause the second chassis unit to travel to the specific location
fourth command: a command to couple the second chassis unit to the specific vehicle body unit at the specific location

After receiving the coupling command, the second chassis unit firstly travels autonomously pursuant to the third command to the specific location. Then, after arriving at the specific location, the second chassis unit operates pursuant to the fourth command to couple itself to the specific vehicle body unit that has been decoupled from the first chassis unit. In consequence, the specific vehicle body unit is enabled to travel using the second chassis unit. In this way, the user can use the separable vehicle without need to perform the operation of replenishing energy source of the chassis unit by himself/herself.

The controller used in the technology according to this disclosure may select as the second chassis unit the chassis unit that is located closest to the aforementioned specific location among the chassis units for which replenishment of energy source has been completed. This method of selection can make the time taken for the second chassis unit to move to the specific location as short as possible, thereby making the time taken to replace the chassis unit as short as possible.

In selecting the second chassis unit, the user may designate the type of the motor. For example, the user may designate either a chassis unit whose motor is an internal combustion engine or a hybrid system or a chassis unit whose motor is an electric motor. In this case, the controller may select as the second chassis unit the chassis unit that is located closest to the aforementioned specific location among the chassis units that has a motor of the type designated by the user and for which replenishment of energy source has been completed. An example of advantages of this method of selection is that if the user intends to travel to an area where there are few charging facilities, the user can employ a chassis unit whose motor is an internal combustion engine or a hybrid system as the chassis unit coupled to the specific vehicle body unit. Likewise, if the user intends to travel to an area where there are many charging facilities, the user can employ a chassis unit whose motor is an electric motor as the chassis unit coupled to the specific vehicle body unit.

In the following, a specific embodiment of the present invention will be described with reference to the drawings. It should be understood that dimensions, materials, shapes, relative arrangements, and other features of the component that will be described in connection with the embodiment are not intended to limit the technical scope of the disclosure only to them, unless otherwise stated.

### Embodiment

What will be described in the following as an embodiment is a case where the information processing apparatus according to this disclosure is applied to a system for managing separable vehicles. This system will also be referred to as the vehicle management system hereinafter.

### <General Configuration of Vehicle Management System>

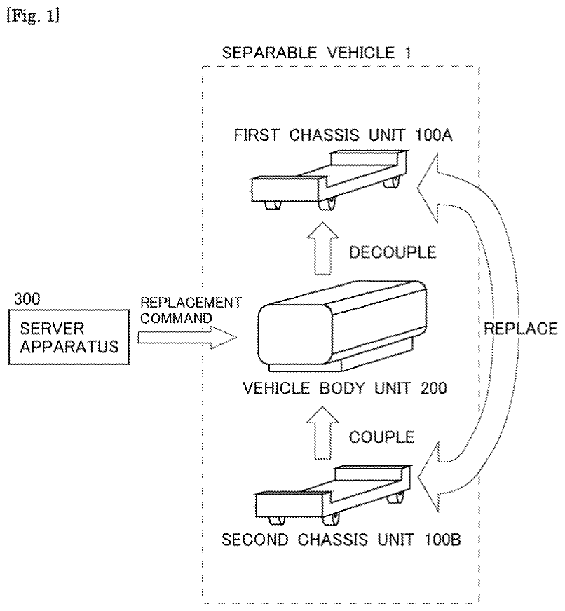

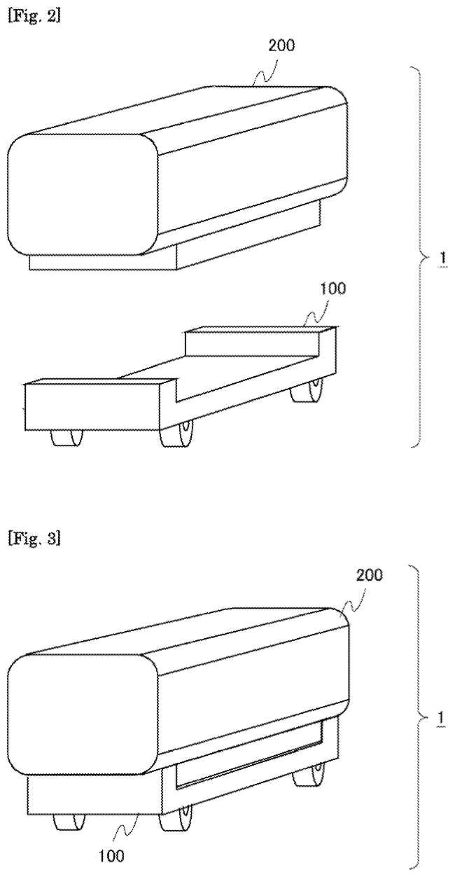

FIG. 1 is a diagram illustrating the general configuration of the vehicle management system. The vehicle management system according to this embodiment includes a separable vehicle 1 and a server apparatus 300. As illustrated in FIGS. 2 and 3, the separable vehicle 1 includes a chassis unit 100 capable of travelling autonomously by autonomous driving and a vehicle body unit 200 having a space for accommodating occupants and/or goods. The chassis unit 100 according to this embodiment is provided with an electric motor serving as the motor of the chassis unit 100 and a battery (or a storage unit) that supplies electric power as energy source to the electric motor. The chassis unit 100 and the vehicle body unit 200 can be coupled to and decoupled from each other. FIG. 2 illustrates the chassis unit 100 and the vehicle body unit 200 in the decoupled state. FIG. 3 illustrates the chassis unit 100 and the vehicle body unit 200 in the coupled state. When coupled to any chassis unit 100, the vehicle body unit 200 can travel on the road with an occupant(s) and/or goods aboard.

When the remaining battery capacity of the chassis unit 100 coupled to the vehicle body unit 200 becomes small, it is necessary to charge the battery of the chassis unit 100. In the system according to the embodiment, when the remaining battery capacity of the chassis unit 100 coupled to the vehicle body unit 200 becomes small, the chassis unit coupled to the vehicle body unit 200 is replaced with a chassis unit for which charging of the battery has been completed. For example, in the case illustrated in FIG. 1, when the remaining battery capacity of the first chassis unit 100A coupled to the vehicle body unit 200 decreases smaller than a predetermined threshold, the first chassis unit 100A is replaced with a second chassis unit 100B for which charging of the battery has been completed, namely a chassis unit whose battery is charged fully (in other words, charged to a level at which further charging is impossible).

The operation of replacing the chassis unit coupled to the vehicle body unit 200 is carried out under the control of the server apparatus 300. Specifically, the server apparatus 300 sends to the first chassis unit 100A a command (decoupling command) for decoupling the first chassis unit 100A from the vehicle body unit 200 at a specific location. Moreover, the server apparatus 300 sends to the second chassis unit 100E a command (coupling command) for coupling the second chassis unit 100B to the vehicle body unit 200 at the specific location. The first chassis unit 100A operates pursuant to the decoupling command to decouple itself from the vehicle body unit 200 at the specific location. Thereafter, the second chassis unit 100B operates pursuant to the coupling command to couple itself to the vehicle body unit 200 from which the first chassis unit 100A has been decoupled at the specific location. The first chassis unit 100A that has been decoupled from the vehicle body unit 200 travels autonomously to a specific charging facility. The specific charging facility may be, for example, the facility closest to the specific location among the facilities for charging batteries of chassis units. The specific charging facility is an example of a specific replenishing facility in the present disclosure. The aforementioned specific location is the location at which the separable vehicle 1 is parked, which may be a parking lot of the user's home or a parking lot of a place of visit. When the separable vehicle 1 is running, the parking lot closest to the present location of the separable vehicle 1 may be selected as the specific location.

### <Hardware Configuration of Vehicle Management System>

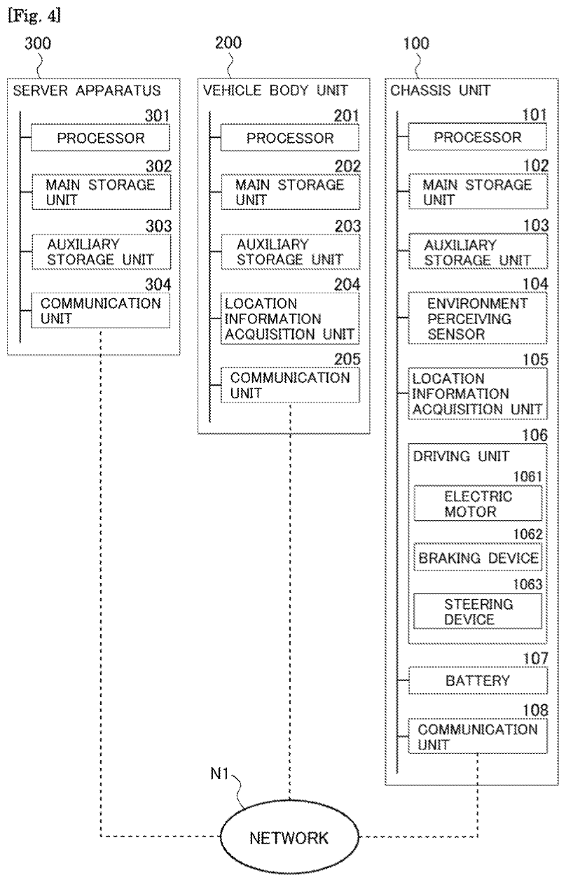

The components of the vehicle management system will now be described specifically. FIG. 4 is a diagram illustrating exemplary hardware configurations of the chassis unit 100, the vehicle body unit 200, and the server apparatus 300 shown in FIG. 1. While FIG. 4 illustrates only one chassis unit 100 and only one vehicle body unit 200, the number of chassis units 100 and the number of vehicle body units 200 under the management of the server apparatus 300 may be two or more.

The chassis unit 100 of the separable vehicle 1 travels on the road pursuant to an operation command. The chassis unit 100 has a processor 101, a main storage unit 102, an auxiliary storage unit 103, an environment perceiving sensor 104, a location information acquisition unit 105, a driving unit 106, a battery 107, and a communication unit 108. The chassis unit 100 used in the system according to the embodiment is an electric car that is driven by an electric motor 1061. The motor of the chassis unit 100 is not limited to the electric motor 1061, but it may be an internal combustion engine or a hybrid system of an internal combustion engine and an electric motor.

The processor 101 may be, for example, a CPU (Central Processing Unit) or a DSP (Digital Signal Processor). The processor 101 controls the chassis unit 100 and executes computation of various information processing. The main storage unit 102 may include a RAM (Random Access Memory), a ROM (Read Only Memory) and/or the like. The auxiliary storage unit 103 may include, for example, an erasable programmable ROM (EPROM) or a hard disk drive (HDD). The auxiliary storage unit 103 may include a removable medium, in other words, a portable recording medium. Examples of the removable medium include a USB (Universal Serial Bus) memory and disc recording media, such as a CD (Compact Disc) and a DVD (Digital Versatile Disc).

What is stored in the auxiliary storage unit 103 includes various programs, various data, and various tables, which can be written into and read out from the auxiliary storage unit 103. The auxiliary storage unit 103 stores an operating system (OS), various programs, and various tables. All or a portion of the aforementioned information and data stored in the auxiliary storage unit 103 may be stored in the main storage unit 102 instead. Likewise, information and data stored in the main storage unit 102 may be stored in the auxiliary storage unit 103 instead.

The environment perceiving sensor 104 is means for sensing the environment of the vehicle, which typically includes a stereo camera, a laser scanner, a LIDAR, a radar, or the like. Information acquired by the environment perceiving sensor 104 is passed to the processor 101.

The location information acquisition unit 105 is a device for acquiring information about the present location of the chassis unit 100, which typically includes a GPS receiver. The location information acquisition unit 105 acquires information about the present location of the chassis unit 100 repeatedly at predetermined intervals. The location information acquired by the positional information acquisition unit 105 is sent to the server apparatus 300 through the communication unit 108, which will be described later. In other words, location information of the chassis unit 100 is sent from the chassis unit 100 to the server apparatus 300 repeatedly at predetermined intervals. Thus, the server apparatus 300 can recognize the present location of each chassis unit 100.

The driving unit 106 is a device that drives the chassis unit 100. The driving unit includes, for example, an electronic motor 1061 serving as the motor of the chassis unit 100, a braking device 1062 for braking the chassis unit 100, and a steering device 1063 for changing the steering angle of the wheels.

The battery 107 is a secondary battery that stores electricity to be supplied to the electric motor 1061 of the driving unit 106. The battery 107 constitutes the storage unit according to the disclosure. In the case where the motor of the chassis unit 100 is an internal combustion engine or a hybrid system, a fuel tank is provided in the chassis unit 100 as the storage unit.

The communication unit 108 is a device that connects the chassis unit 100 to a network Ni. The communication unit 108 connects itself with the network N1 using mobile communications, such as 5G (5th Generation) mobile communications or LTE (Long Term Evolution) mobile communications. Alternatively, the communication unit 108 may connect itself with the network N1 using narrow-band communications, such as DSRC (Dedicated Short Range Communications), or Wi-Fi (registered trademark). Thus, the communication unit 108 can communicate with other devices such as the vehicle body unit 200 and the server apparatus 300, via the network N1. For example, the communication unit 108 sends the present location information acquired by the location information acquisition unit 105 and information about the remaining charge in the battery 107 (or the remaining battery capacity) to the server apparatus 300 via the network N1. The network N1 may be, for example, a WAN (Wide Area Network), which may be a global public communication network such as the Internet, or other communication network.

The hardware configuration of the chassis unit 100 is not limited to that illustrated in FIG. 4, but some components may be eliminated, replaced, or added. For example, the chassis unit 100 may be provided with an apparatus used to perform the operation of coupling it with and/or decoupling it from the vehicle body unit 200. Examples of such an apparatus include a heavy machine equipped with a lift or crane and an electromagnet device. Various processing executed by the chassis unit 100 may be executed by either hardware or software.

The vehicle body unit 200 has a space for accommodating occupants and/or goods. The vehicle body unit 200 has a processor 201, a main storage unit 202, an auxiliary storage unit 203, a location information acquisition unit 204, and a communication unit 205. The processor 201, the main storage unit 202, the auxiliary storage unit 203, the location information acquisition unit 204, and the communication unit 205 are similar to their corresponding components of the chassis unit 100 and therefore will not be described further.

The hardware configuration of the vehicle body unit 200 is not limited to that illustrated in FIG. 4, but some components may be eliminated, replaced, or added. Various processing executed by the vehicle body unit 200 may be executed by either hardware or software.

The server apparatus 300 is an apparatus that manages the separable vehicle 1 (including the chassis unit 100 and the vehicle body unit 200). The server apparatus 300 constitutes the information processing apparatus according to the disclosure. The server apparatus 300 has a configuration as an ordinary computer. The server apparatus 300 has a processor 301, a main storage unit 302, an auxiliary storage unit 303, and a communication unit 304. The processor 301, the main storage unit 302, the auxiliary storage unit 303, and the communication unit 304 are interconnected by busses. The processor 301, the main storage unit 302, and the auxiliary storage unit 303 are similar to their corresponding components of the chassis unit 100 and therefore will not be described further. The communication unit 304 performs communication of information between the server apparatus 300 and external devices. The communication unit 304 may include, for example, a LAN (Local Area Network) interface board or a wireless communication circuit for wireless communication. The LAN interface board or the wireless communication circuit is connected to the network N1. The hardware configuration of the server apparatus 300 is not limited to that illustrated in FIG. 4, but some components may be eliminated, replaced, or added. Various processing executed by the server apparatus 300 may be executed by either hardware or software.

### <Functional Configuration of Chassis Unit>

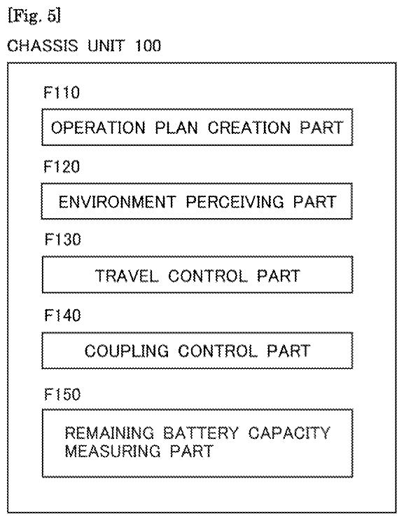

The functional configuration of the chassis unit 100 will now be described with reference to FIG. 5. As illustrated in FIG. 5, the chassis unit 100 according to this embodiment includes, as functional components, an operation plan creation part F110, an environment perceiving part F120, a travel control part F130, a coupling control part F140, and a remaining battery capacity measuring part F150. The chassis unit 100 implements these functional components by executing programs stored in the main storage unit 102 or the auxiliary storage unit 103 by the processor 101. One or some of the operation plan creation part F110, the environment perceiving part F120, the travel control part F130, the coupling control part F140, and the remaining battery capacity measuring part F150 may be implemented entirely or partly by a hardware circuit(s). One or some of the above functional components or a part of the processing of them may be implemented by another computer(s) connected to the network N1. For example, the processing executed as the operation plan creation part F110, the processing executed as the environment perceiving part F120, the processing executed as the travel control part F130, the processing executed as the coupling control part F140, and the processing executed as the remaining battery capacity measuring part F150 may be executed by different computers.

The operation plan creation part F110 is configured to create an operation plan of the chassis unit 100 on the basis of an operation command sent from the server apparatus 300. The operation plan is data specifying a route along which the chassis unit 100 is to travel and an operation(s) that the chassis unit 100 is to perform in a part or the entirety of the route. Examples of data included in the operation plan are as follows.

(1) Data that Specifies a Route along Which the Chassis Unit 100 is Planned to Travel (Planned Travel Route) by a Set of Road Links

The planned travel route mentioned above may be created, for example, by the operation plan creation part F110 based on the command sent from the server apparatus 300 using map data stored in the auxiliary storage unit 103 or other storage means. Alternatively, the planned travel route may be created using an external service or supplied by the server apparatus 300.

(2) Data that Specifies an Operation(s) to be Performed by the Chassis Unit 100 at a Certain Location(s) in the Planned Travel Route

Examples of the aforementioned certain location include a location at which the chassis unit 100 and the vehicle body unit 200 are decoupled from or coupled to each other. An example of the operation to be performed by the chassis unit 100 at the specific location includes, but is not limited to, decoupling/coupling the chassis unit 100 from/to the vehicle body unit 200.

The environment perceiving part F120 is configured to perceive the environment around the chassis unit 100 using data acquired by the environment perceiving sensor 104. What is perceived by the environment perceiving part F120 includes, but is not limited to, the number and the position of lanes, the number and the position of vehicles present around the chassis unit 100, the number and the position of obstacles present around the chassis unit 100, the structure of the road, and road signs. What is perceived by the environment perceiving part F120 may include anything that is useful for autonomous traveling of the chassis unit 100. The environment perceiving part F120 may be configured to perform tracking of a perceived object. For example, the environment perceiving part F120 may be configured to calculate the relative speed of the perceived object from the difference between the coordinates of the object determined in a previous step and the present coordinates of it.

The travel control part F130 is configured to control the travel of the chassis unit 100 on the basis of the operation plan created by the operation plan creation part F110, environment data created by the environment perceiving part F120, and the location information of the chassis unit 100 acquired by the location information acquisition part 105. For example, the travel control part F130 causes the chassis unit 100 to travel along the planned travel route created by the operation plan creation part F110. In doing so, the travel control part F130 causes the chassis unit 100 to travel so that obstacles will not enter a predetermined safety zone around the chassis unit 100. A known method may be employed to cause the chassis unit 100 to travel autonomously. Moreover, the travel control part F130 has the function of controlling the travel of the chassis unit 100 pursuant to the command sent from the server apparatus 300.

The remaining battery capacity measuring part F150 is configured to measure the remaining charge in the battery 107 (or the remaining battery capacity). For example, the remaining battery capacity measuring part F150 measures the remaining battery capacity using an SOC sensor or the like attached to the battery 107. Information about the remaining battery capacity (battery information) acquired by the remaining battery capacity measuring part F150 is sent to the server apparatus 300 through the communication unit 304 repeatedly at predetermined intervals. The battery information sent contains information for identification of the chassis unit 100 (or chassis ID) in addition to information about the remaining battery capacity.

The coupling control part F140 is configured to control coupling and decoupling of the chassis unit 100 and the vehicle body unit 200 to and from each other. In the case where coupling and decoupling of the chassis unit 100 and the vehicle body unit 200 are carried out by an external apparatus, the coupling control part F140 controls this external apparatus by wireless communication or the like to carry out the operations of coupling and decoupling the chassis unit 100 and the vehicle body unit 200. In the case where the chassis unit 100 is provided with an apparatus that carries out coupling and decoupling of the chassis unit 100 and the vehicle body unit 200, the coupling control part F140 controls this apparatus to carry out the operations of coupling and decoupling the chassis unit 100 and the vehicle body unit 200.

### <Functional Configuration of Server Apparatus>

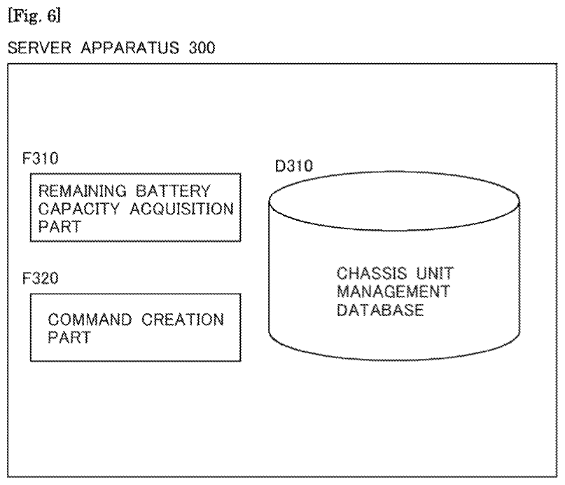

The functional configuration of the server apparatus 300 will be described next with reference to FIG. 6. As illustrate in FIG. 6, the server apparatus 300 in the system according to this embodiment includes, as functional components, a remaining battery capacity acquisition part F310, a command creation part F320, and a chassis unit management database D310. The server apparatus 300 implements the remaining battery capacity acquisition part F310 and the command creation part F320 by executing programs stored in the main storage unit 302 or the auxiliary storage unit 303 by the processor 301. The remaining battery capacity acquisition part F310 or the command creation part F320 may be implemented entirely or partly by a hardware circuit(s). The remaining battery capacity acquisition part F310 or the command creation part F320 or a part of the processing of them may be implemented by another computer(s) connected to the network N1. For example, the processing executed as the remaining battery capacity acquisition part F310 and the processing executed as the command creation part F320 may be executed by different computers.

The chassis unit management database D310 is created by a database management system program (DBMS program) executed by the processor 301. Specifically, the chassis unit management database D310 is created by managing data stored in the auxiliary storage unit 303 by the DBMS program. The chassis unit management database D310 is, for example, a relational database.

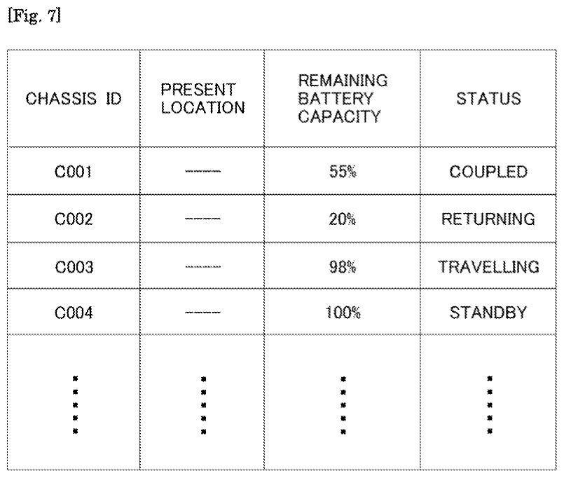

What is stored in the chassis unit management database D310 is information about the chassis units 100 that are under the management of the server apparatus 300. The chassis unit management database D310 stores identification data of each chassis unit 100 and information about the chassis unit 100, which are linked with each other. An exemplary structure of the information stored in the chassis unit management database D310 will be described with reference to FIG. 7. FIG. 7 illustrates the structure of a table stored in the chassis unit management database D310. The structure of the table stored in the chassis unit management database D310 (which will be also referred to as “chassis unit information table” hereinafter) is not limited to that illustrated in FIG. 7, but some fields may be added, changed, or removed fitly.

The chassis unit information table shown in FIG. 7 has the fields of chassis ID, present location, remaining battery capacity, and status. What is stored in the chassis ID field is information identifying each chassis unit (chassis ID). What is stored in the present location field is information indicating the present location of each chassis unit 100. The information stored in the present location field may be the address of the place where each chassis unit 100 is located or information indicating the coordinates on a map (or longitude and latitude) of the location where each chassis unit 100 is located. What is stored in the remaining battery capacity field is information indicating the remaining charge in the battery 107 in each chassis unit 100. In the system according to the embodiment, information indicating the percentage (%) of the remaining charge to the full charge of the battery 107 is stored in this field. What is stored in the status field is information indicating the status of each chassis unit 100. For example, when the chassis unit 100 is in the state coupled with a vehicle body unit 200, the information “coupled” is stored in this field. When the chassis unit 100 is in the state not coupled with a vehicle body unit 200 and travelling to a specific charging facility, the information “returning” is stored in this field. When the chassis unit 100 is travelling to a place (or specific location) at which it is to be coupled with a vehicle body unit 200, the information “travelling” is stored in this field. When the chassis unit 100 is on standby at a charging facility or other places, the information “standby” is stored in this field.

The remaining battery capacity acquisition part F310 acquires the remaining battery capacity of each chassis unit 100. In the system according to the embodiment, the remaining battery capacity acquisition part F310 acquires the remaining battery capacity by receiving the battery information sent from each chassis unit 100 to the server apparatus 300 through the communication unit 304. The battery information includes information indicating the remaining charge in the battery 107 (remaining battery capacity) of each chassis unit 100 and the chassis ID of the chassis unit 100. After acquiring the remaining battery capacity in this way, the remaining battery capacity acquisition part F310 accesses the chassis unit management database D310 with the chassis ID to update the information stored in the remaining battery capacity field in the chassis unit information table associated with the chassis ID. In this process, if the information stored in the status field of the chassis unit information table is “coupled”, the remaining battery capacity acquisition part F310 determines whether or not the remaining battery capacity acquired is smaller than a predetermined threshold. The predetermined threshold is a criterion below which it is determined that the battery 107 needs to be charged. In the system according to the embodiment., the predetermined threshold is set, for example, as a value of the remaining battery capacity below which the chassis unit 100 is expected to be unable to travel to the closest charging facility. If the remaining battery capacity is smaller than the predetermined threshold, the remaining battery capacity acquisition part F310 passes the information about the remaining battery capacity and the chassis ID to the command creation part F320.

The command creation part F320 creates commands for replacing the chassis unit 100 (first chassis unit 100A) whose remaining battery capacity is smaller than the predetermined threshold with a chassis unit 100 (second chassis unit 100B) for which charging of the battery 107 has been completed. These commands include a command (decoupling command) for decoupling the first chassis unit 100A from the vehicle body unit 200 and a command (coupling command) for coupling a second chassis unit 100B to the vehicle body unit 200.

The decoupling command is a command for decoupling the first chassis unit 100A from the vehicle body unit 200 at a specific location. The decoupling command includes the first and second commands as follows:
first command: a command to decouple the first chassis unit 100A from the vehicle body unit 200 at a specific location
second command: a command to cause the first chassis unit 100A to travel from the specific location to a specific charging facility

The specific location is the location at which the first chassis unit 100A is parked, namely the present location of the first chassis unit 100A. When the first chassis unit 100A is running, the specific location is set to the parking lot closest to the present location of the first chassis unit 100A. In this case, the decoupling command may further include a command (travel command) to cause the first chassis unit 100A to travel from its present location to the specific location in addition to the first and second commands. The specific charging facility is the charging facility closest to the specific location.

The coupling command is a command for coupling a second chassis unit 100B to the vehicle body unit 200 at the specific location. The coupling command may include third and fourth commands as follows:
third command: a command to cause a second chassis unit 100B to travel to the specific location
fourth command: a command to couple the second chassis unit 100B to the vehicle body unit 200 at the specific location

The decoupling command created by the command creation part F320 is sent to the first chassis unit 100A through the communication unit 304. The coupling command created by the command creation part F320 is sent to a second chassis unit 100B through the communication unit 304. The second chassis unit 100B to which the coupling command is to be sent is determined based on information stored in the chassis unit management database D310. For example, the command creation part F320 firstly extracts chassis units 100 of which the information stored in the status field and the information stored in the remaining battery capacity field of the chassis unit information table are “standby” and “100%” respectively. Then, the command creation part F320 selects as the second chassis unit 100B the chassis unit 100 whose present location as per the present location field of the chassis unit information table is closest to the specific location among the extracted chassis units 100. The method of selecting the second chassis unit 100B to which the coupling command is to be sent is not limited to this. Alternatively, for example, the command creation part F320 may select as the second chassis unit 100B the chassis unit 100 whose expected time of arrival to the specific location, which may be calculated based on traffic information and other information, is the earliest.

### <Process Performed by the Server Apparatus>

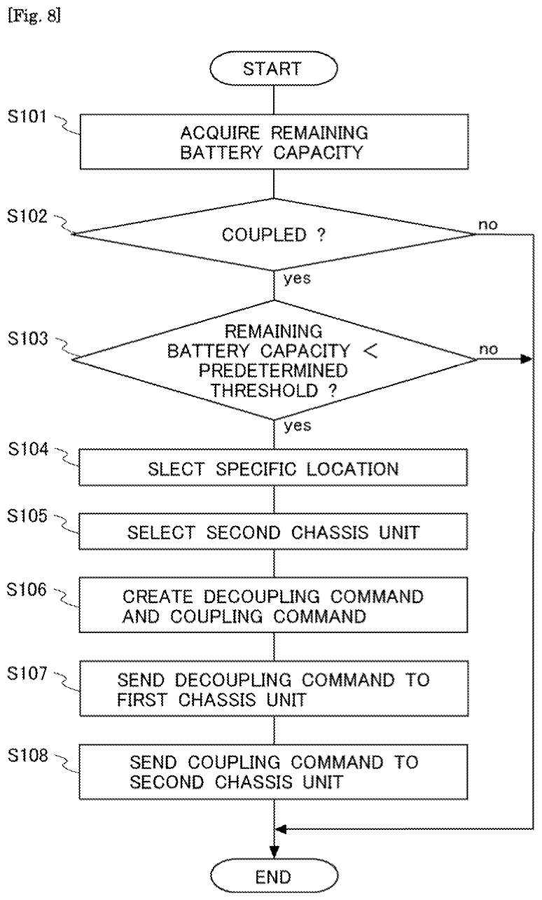

A process performed by the server apparatus 300 in the system according to the embodiment will be described with reference to FIG. 8. FIG. 8 is a flow chart of the process performed by the server apparatus 300 when it receives the battery information sent from the first chassis unit 100A.

In the process according to the flow chart of FIG. 8, when the communication unit 304 of the server apparatus 300 receives the battery information sent from the first chassis unit 100A, the remaining battery capacity acquisition part F310 acquires information about the remaining battery capacity contained in the battery information (step S101). Then, the remaining battery capacity acquisition part F310 accesses the chassis unit management database D310 with the chassis ID contained in the battery information. Specifically, the remaining battery capacity acquisition part F310 accesses the chassis unit information table associated with the first chassis unit 100A to update the information stored in the remaining battery capacity field of the chassis unit information table by the information about the remaining battery capacity acquired as above.

The remaining battery capacity acquisition part F310 determines whether or not the information stored in the status field of the aforementioned chassis unit information table is “coupled” (step S102). In other words, the remaining battery capacity acquisition part F310 determines whether or not the first chassis unit 100A is coupled with a vehicle body unit 200. If the information stored in the status field of the aforementioned chassis unit information table is “travelling”, “returning”, or “standby” (a negative answer in step S102), the process according to the flow chart of FIG. 8 is terminated. On the other hand, if the information stored in the status field of the aforementioned chassis unit information table is “coupled” (an affirmative answer in step S102), then the remaining battery capacity acquisition part F310 determines whether or not the remaining battery capacity is smaller than the predetermined threshold (step S103). If the remaining battery capacity determined in step S101 is equal to or larger than the predetermined threshold (a negative answer in step S103), the process according to the flow chart of FIG. 8 is terminated. On the other hand, if the remaining battery capacity determined in step S101 is smaller than the predetermined threshold (an affirmative answer in step S103), the remaining battery capacity acquisition part F310 passes the remaining battery capacity and the chassis ID of the first chassis unit 100A to the command creation part F320.

The command creation part F320 selects a location (specific location) at which the first chassis unit 100A is to be decoupled from the vehicle body unit 200 (step S104). For example, the command creation part F320 selects the location at which the first chassis unit 100A is parked as the specific location. When the first chassis unit 100A is running, the command creation part F320 may select the parking lot closest to the present location of the first chassis unit 100A as the specific location.

Then, the command creation part F320 selects a second chassis unit 100B (step S105). For example, the command creation part F320 accesses the chassis unit management database D310 to extract the chassis unit information tables that store the information “standby” in their status fields and the information “100%” in their remaining battery capacity fields. Then, the command creation part F320 determines the chassis unit information table of which the present location indicated by the information stored in its present location field is closest to the specific location selected in step S104 among the extracted chassis unit information tables. The command creation part F320 selects the chassis unit 100 associated with the chassis unit information table thus determined as the second chassis unit 100B.

Then, the command creation part F320 creates a decoupling command and a coupling command (step S106). The decoupling command includes the aforementioned first and second commands. In the case where the first chassis unit 100A is running, the decoupling command includes the aforementioned travel command in addition to the first and second commands. The coupling command includes the aforementioned third and fourth commands.

The decoupling command created in step S106 is sent to the first chassis unit 100A through the communication unit 304 (step S107). After the first chassis unit 100A receives the decoupling command, the operation plan creation part F110 of the first chassis unit 100A creates an operation plan based on the decoupling command. As described previously, the operation plan includes data that specifies a planned travel route of the first chassis unit 100A by a set of road links and data that specifies an operation(s) to be performed by the first chassis unit 100A at a certain location(s) in the planned travel route. The operation plan in the system according to the embodiment includes data specifying a planned travel route from the specific location to a specific charging facility and data specifying an operation to be performed by the first chassis unit 100A at the specific location. In the case where the first chassis unit 100A is running, the operation plan includes data specifying a planned travel route from the present location to the specific charging facility via the specific location and data specifying an operation to be performed by the first chassis unit 100A at the specific location. The operation to be performed by the first chassis unit 100A at the specific location is to decouple the first chassis unit 100A from the vehicle body unit 200. Given this operation plan, the coupling control part F140 of the first chassis unit 100A controls an external apparatus or an apparatus provided on the first chassis unit 100A to decouple the first chassis unit 100A from the vehicle body unit 200. After the completion of decoupling of the first chassis unit 100A from the vehicle body unit 200 at the specific location, the travel control part F130 starts to control the travel of the first chassis unit 100A. Specifically, the travel control part F130 controls the travel of the first chassis unit 100A by controlling the driving unit 106 on the basis of the aforementioned planned travel route, the environment data created by the environment perceiving part F120, and location information acquired by the location information acquisition unit 105. Thus, the first chassis unit 100A can travel autonomously from the specific location to the specific charging facility by autonomous driving.

The coupling command created in step S106 is sent to the second chassis unit 100B through the communication unit 304 (step S108). After the second chassis unit 100R receives the coupling command, the operation plan creation part F110 of the second chassis unit 100B creates an operation plan based on the coupling command. This operation plan includes data specifying a planned travel route from the location at which the second chassis unit 100B is on standby to the specific location and data specifying an operation to be performed by the second chassis unit 100B at the specific location. The operation to be performed by the second chassis unit 100B at the specific location is to couple the second chassis unit 100B to the vehicle body unit 200 from which the first chassis unit 100A has been decoupled. Given this operation plan, the travel control part F130 of the second chassis unit 100B starts to control the travel of the second chassis unit 100B. Specifically, the travel control part F130 controls the travel of the second chassis unit 100B by controlling the driving unit 106 on the basis of the aforementioned planned travel route, the environment data created by the environment perceiving part F120, and location information acquired by the location information acquisition unit 105. Thus, the second chassis unit 100B can travel autonomously from the location at which the second chassis unit 100B is on standby to the specific location by autonomous driving. After the second chassis unit 100B arrives at the specific location, the coupling control part F140 of the second chassis unit 100B couples the second chassis unit 100B to the vehicle body unit 200.

As per the above process according to the flow chart of FIG. 8, when the remaining battery capacity of a chassis unit coupled with a vehicle body unit becomes smaller than the threshold, the chassis unit coupled with the vehicle body unit can be replaced automatically with another chassis unit with a fully-charged battery. This can save users of separable vehicles the trouble of charging the battery of the chassis unit by themselves. Moreover, this system can save the users the cost of providing a charging facility in their home or other places. Therefore, this system can enhance the convenience of the users of separable vehicles.

### Others

The above embodiment has been described only by way of example. Changes can be made to the above embodiment without departing from the essence of the technology disclosed herein.

The processing and means that have been described in this disclosure may be employed in any combination so long as it is technically feasible to do so. One, some, or all of the processes that have been described as processes performed by a single apparatus may be performed by a plurality of apparatuses in a distributed manner. One, some, or all of the processes that have been described as processes performed by a plurality of apparatuses may be performed by a single apparatus. The hardware configuration employed to implement various functions in a computer system may be modified flexibly.

The technology according to this disclosure can be carried out by supplying a computer program(s) (or information processing program(s)) that implements the functions described in the above description of the embodiment to a computer to let one or more processors of the computer read and execute the program(s). Such a computer program(s) may be supplied to the computer by a computer-readable, non-transitory storage medium that can be connected to a system bus of the computer or through a network. The computer-readable, non-transitory storage medium refers to a recording medium that can store information, such as data and programs, electrically, magnetically, optically, mechanically, or chemically in such a way as to allow the computer or the like to read the stored information. Examples of the computer-readable, non-transitory storage medium include any type of disc medium including a magnetic disc, such as a floppy disc (registered trademark) and a hard disk drive (HDD), and an optical disc, such as a CD-ROM, a DVD, and a Blu-ray disc. Further examples of the computer-readable, non-transitory storage medium include a read-only memory (ROM), a random access memory (RAM), an EPROM, an EEPROM, a magnetic card, a flash memory, an optical card, and a solid state drive (SSD).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information processing apparatus for managing a separable vehicle including a vehicle body unit having a space capable of accommodating an occupant and/or goods and a chassis unit adapted to be coupled to and decoupled from the vehicle body unit and having a motor and a storage unit that stores energy source of the motor, comprising a controller including at least one processor,
the controller configured to execute the processing of
acquiring a remaining amount of energy source defined as the remaining amount of energy source stored in the storage unit of a first chassis unit coupled with a specific vehicle body unit; and
when the remaining amount of energy source is smaller than a predetermined threshold, sending a decoupling command to the first chassis unit and sending a coupling command to a second chassis unit for which replenishment of energy source has been completed, the decoupling command being a command to decouple the first chassis unit from the vehicle body unit, and the coupling command being a command to couple the second chassis unit to the specific vehicle body unit.

2. The information processing apparatus according to claim 1, wherein the first chassis unit and the second chassis unit are configured to be capable of travelling autonomously.

3. The information processing apparatus according to claim 2, wherein the decoupling command includes a command to decouple the first chassis unit from the specific vehicle body unit at a specific location and a command to cause the first chassis unit to travel from the specific location to a specific replenishing facility.

4. The information processing apparatus according to claim 3, wherein the coupling command includes a command to cause the second chassis unit to travel to the specific location and a command to couple the second chassis unit to the specific vehicle body unit at the specific location.

5. The information processing apparatus according to claim 4, wherein the controller selects as the second chassis unit the chassis unit that is located closest to the specific location among chassis units for which replenishment of energy source has been completed.

6. The information processing apparatus according to claim 1, wherein the motor is an electric motor, and the energy source is electricity stored in a battery as the storage unit.

7. The information processing apparatus according to claim 1, wherein the motor is an internal combustion engine, and the energy source is fuel stored in a fuel tank as the storage unit.

8. A non-transitory storage medium stored with an information processing program for managing a separable vehicle including a vehicle body unit having a space capable of accommodating an occupant and/or goods and a chassis unit adapted to be coupled to and decoupled from the vehicle body unit and having a motor and a storage unit that stores energy source of the motor,
the information processing program configured to cause a computer to execute the processing of:
acquiring a remaining amount of energy source defined as the remaining amount of energy source stored in the storage unit of a first chassis unit coupled with a specific vehicle body unit; and
when the remaining amount of energy source is smaller than a predetermined threshold, sending a decoupling command to the first chassis unit and sending a coupling command to a second chassis unit for which replenishment of energy source has been completed, the decoupling command being a command to decouple the first chassis unit from the vehicle body unit, and the coupling command being a command to couple the second chassis unit to the specific vehicle body unit.

9. The non-transitory storage medium according to claim 8, wherein the first chassis unit and the second chassis unit are configured to be capable of travelling autonomously.

10. The non-transitory storage medium according to claim 9, wherein the decoupling command includes a command to decouple the first chassis unit from the specific vehicle body unit at a specific location and a command to cause the first chassis unit to travel from the specific location to a specific replenishing facility.

11. The non-transitory storage medium according to claim 10, wherein the coupling command includes a command to cause the second chassis unit to travel to the specific location and a command to couple the second chassis unit to the specific vehicle body unit at the specific location.

12. The non-transitory storage medium according to claim 11, wherein the information processing program configured to cause the computer to further execute the processing of selecting as the second chassis unit the chassis unit that is located closest to the specific location among chassis units for which replenishment of energy source has been completed.

13. The non-transitory storage medium according to claim 8, wherein the motor is an electric motor, and the energy source is electricity stored in a battery as the storage unit.

14. The non-transitory storage medium according to claim 8, wherein the motor is an internal combustion engine, and the energy source is fuel stored in a fuel tank as the storage unit.

15. An information processing method for managing a separable vehicle including a vehicle body unit having a space capable of accommodating an occupant and/or goods and a chassis unit adapted to be coupled to and decoupled from the vehicle body unit and having a motor and a storage unit that stores energy source of the motor, comprising the following steps of processing executed by a computer:
acquiring a remaining amount of energy source defined as the remaining amount of energy source stored in the storage unit of a first chassis unit coupled with a specific vehicle body unit; and
when the remaining amount of energy source is smaller than a predetermined threshold, sending a decoupling command to the first chassis unit and sending a coupling command to a second chassis unit for which replenishment of energy source has been completed, the decoupling command being a command to decouple the first chassis unit from the vehicle body unit, and the coupling command being a command to couple the second chassis unit to the specific vehicle body unit.

16. The information processing method according to claim 15, wherein the first chassis unit and the second chassis unit are configured to he capable of travelling autonomously.

17. The information processing method according to claim 16, wherein the decoupling command includes a command to decouple the first chassis unit from the specific vehicle body unit at a specific location and a command to cause the first chassis unit to travel from the specific location to a specific replenishing facility

18. The information processing method according to claim 17, wherein the coupling command includes a command to cause the second chassis unit to travel to the specific location and a command to couple the second chassis unit to the specific vehicle body unit at the specific location.

19. The information processing method according to claim 18, further comprising the step of processing executed by the computer of selecting as the second chassis unit the chassis unit that is located closest to the specific location among chassis units for which replenishment of energy source has been completed.

20. The information processing method according to claim 15, wherein the motor is an electric motor, and the energy source is electricity stored in a battery as the storage unit.
